(19) United States
(12) Patent Application Publication
(10) Pub. No.: US 2008/0239919 A1
(43) Pub. Date: Oct. 2, 2008

(54) DISC MEDIUM AND DISC DEVICE USING THE SAME

(76) Inventor: Hideki Maruyama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/056,323

(22) Filed: Mar. 27, 2008

(30) Foreign Application Priority Data
Mar. 28, 2007 (JP) 2007-083275

(51) Int. Cl. G11B 7/242

(52) U.S. Cl. 369/94

(57) ABSTRACT

A multi-layer disc medium includes two or more reproducing or recording and reproducing layers. One or more layers have a layer information area portion formed by at least a part of a circular path extending circumferentially of the layer. The circular paths have a center coincident with a center axis of rotation of the disc medium and are at substantially identical radial positions from the center axis of rotation of the disc medium. Layer information capable of identifying a layer concerned is disposed on at least the part of the circular path on the layer. By reading the layer information at an inter-layer transference, verification of an accessed layer can be performed simply and quickly, leading to a simple and quick inter-layer transference.

### INCORPORATION BY REFERENCE

The present application claims priority from Japanese application JP2007-083275 filed on Mar. 28, 2007, the content of which is hereby incorporated by reference into this application.

### BACKGROUND OF THE INVENTION

The present invention relates to multi-layered disc media and disc devices.

The recording and reproducing apparatuses employing a disc medium tend to store a more and more increased amount of information with an improvement of the recording and reproducing technology. Meanwhile, since the amount of data allowed to be dealt with by computers has been increased due to the recent progress of the high-speed LSI technologies, the recording apparatuses are now highly required to have a larger storage capacity. In addition, as a medium for storing program contents of the television broadcasting, which is now widely performed under the high definition television (HDTV) broadcasting scheme, the recording and reproducing apparatuses employing a disc medium are greatly required to store an increased amount of information.

In these circumstances, it is conjectured that the recording density on a disc will be enhanced and the disc devices will undergo a modification to a multi-layered structure for a larger storage capacity. However, with a multi-layered structure, it is possible that, when a pick-up is transferred to one disc layer to another, it may access a wrong layer other than the target layer.

Under such a background, a technique for coping with this problem is disclosed, for example, in JP-A-2005-85437, according to which: “use is made of a disc format capable of achieving discrimination of disc layers under the FSK system or the PSK system which has a high demodulation performance of the wobble modulation scheme and complies with use of common demodulation circuits, thereby assuring the discrimination of disc layers, free from a long wait that may be caused by retrial steps, without a considerable increase of circuits.”

### SUMMARY OF THE INVENTION

Under the conventional technique, specific wobbles may be formed in the entire surface of a disc which is costly, and use may be made of signals reliable only when the servosystem with wobble signals is stabilized which requires servo control, and it may take rather a long time to stabilize the servosytem.

One object of the present invention is to provide, at low costs, a disc medium having a plurality of layers in which a target layer can be detected simply and rapidly for inter-layer transference of a recording and reproducing pick-up.

Another object of the present invention is to provide a disc device using a disc medium of the type described above.

According to one aspect of the present invention, a multi-layered disc medium includes at least one layer having layer information for identifying a layer concerned, the layer information being read for transference of a recording and reproducing pick-up to a target layer.

According to another aspect of the present invention, a multi-layered disc medium includes at least one layer having layer information for identifying a layer concerned, in which the layer information is disposed on at least a part of a circular path extending circumferentially of the layer so that a layer information area portion is formed by a part of or the whole of the circular path carrying the layer information, and the circular path has a center coincident with a center axis of rotation of the disc medium, the layer information being read for transference of a recording and reproducing pick-up to a target layer.

According to another aspect of the present invention, a multi-layered disc medium includes two or more layers each having layer information for identifying a layer concerned, in which the layer information for each of the two or more layers is disposed on at least a part of a circular path extending circumferentially of the layer concerned so that a layer information area portion is formed on each of the two or more layers by a part of or the whole of the circular path carrying the layer information, and the circular paths on the two or more layers have a center coincident with a center axis of rotation of the disc medium and are at substantially identical radial positions from the center axis of rotation of the disc medium, the layer information being read for transference of a recording and reproducing pick-up to a target layer.

The layer information disposed circumferentially of on one or more layers may be in the form of a bar code, a two-dimensional code, or the like.

In one sense, the present invention is advantageous in that a recording and reproducing pick-up is transferred among disc layers of a multi-layered disc medium simply to make it possible to start recording and reproducing operations quickly.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are sectional diagrams of a disc medium according to embodiments of the present invention.

FIG. 2 is a diagram indicating a process of transference of a recording and reproducing pick-up between layers of a disc medium according to another embodiment of the present invention.

FIGS. 3A and 3B are diagrams of disc media, as viewed in the direction of the disc rotation axis, according to other embodiments of the present invention.

FIGS. 4A and 4B are sectional diagrams of disc media according to other embodiments of the present invention.

FIG. 5 is a schematic structural diagram of a disc device according to another embodiment of the present invention.

### DESCRIPTION OF THE EMBODIMENTS

Embodiments of the present invention will now be described with reference to the accompanying drawings.

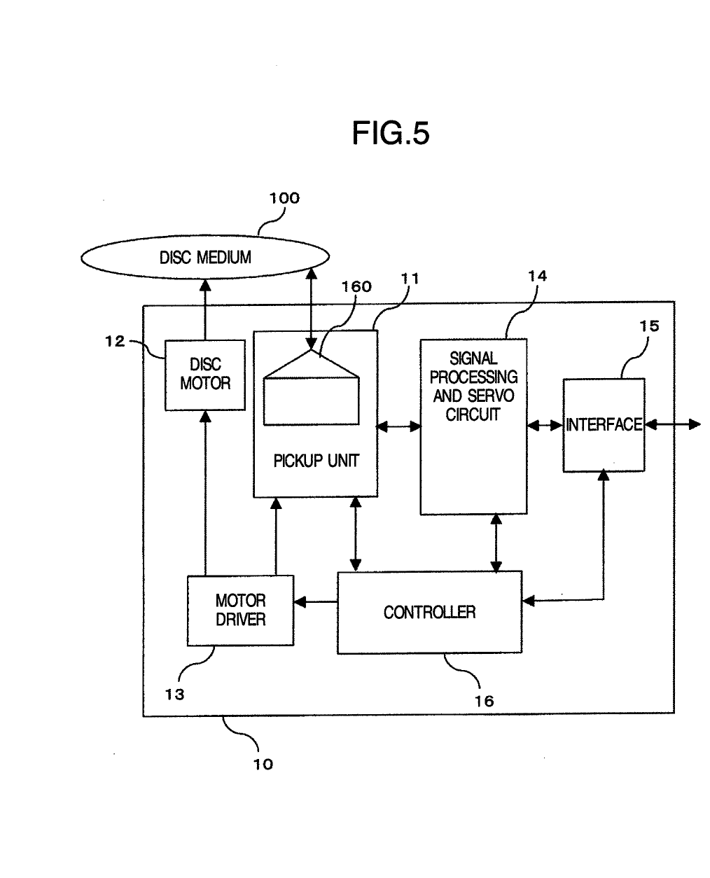

FIG. 5 schematically illustrates a disc device 10 capable of a reproducing operation or reproducing and recording operations in cooperation with a disc medium, according to an embodiment of the present invention. The disc device 10 includes a disc motor 12 for rotation-driving a disc medium 100, a pickup unit 11 having a recording and reproducing pick-up 160, a motor driver 13, signal processing and servo circuit 14, an interface 15 to an external device such as a PC host, and a controller 16.

The recording and reproducing pick-up 160 has a semiconductor laser serving as a light source, an optical system for conducting a light beam generated by the semiconductor laser to the disc medium 100 and for conducting a return light beam caused by reflection at the disc medium 100 to a predetermined light-receiving position, and a light receiving means for receiving the return light beam. Although the pickup unit 11 further has an actuator for controlling the recording and reproducing pick-up 160, a drive system such as a seek motor and others, they are omitted in FIG. 5.

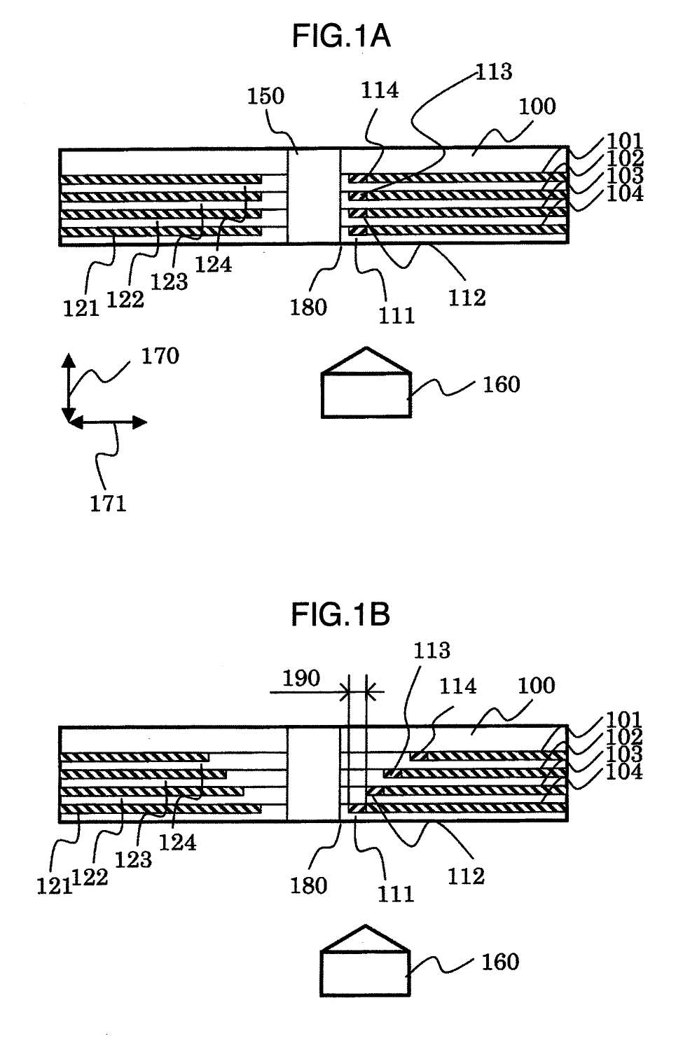

FIGS. 1A and 1B show in section disc media according to embodiments of the present invention, in which a multi-layered disc medium in each embodiment has, as an example, four disc layers. Thus, the disc medium 100 has four layers 101 to 104 having layer information area portions 111 to 114, which carry bar codes, respectively, as an example of the layer information. Each of the layer information area portions 111 to 114 carries layer information uniquely related to the layer concerned. Here, the layer information is in the form of a bar code. Each bar code includes, for example, a series of alternately arranged high and low reflectivity sections. Thus, the bar code for each of the layers is disposed on a part of a circular path extending circumferentially of the layer so that the information area portion of the layer is formed by the part of the circular path carrying the bar code. The circular paths on the layers have a center coincident with a center axis of rotation of the disc medium 100. The width of each layer information area portion is in the radial direction of the layer.

Further, the disc medium 100 has data area portions 121 to 124 on the respective layers on which data can be recorded or reproduced. With the disc medium 100 being rotated by the disc motor 12 with the aid of the disc medium clamp 150, the recording and reproducing pick-up 160 in the disc device 10 emits a laser light beam to the disc medium 100 and receives a reflection light beam therefrom to read the bar code from one of the layer information area portions 111 to 114 of the disc layers 101 to 104, in which the recording and reproducing operations are to be performed on one disc layer carrying the read bar code. The disc device 100 checks the read bar code, and records/reproduces data on the data area portion, among the data area portions 121 to 124, of the corresponding layer. The recording and reproducing pick-up 160 is subject to a focusing control 170 thicknesswise of the disc medium 100 and to a tracking control 171 radially of the disc medium 100.

To read and reproduce the bar codes disposed on the layer information area portions 111 to 114 with the disc medium 100 being rotated, only the focusing control 170 is necessary without the tracking control 171, as the bar codes are made of one-dimensional information. Meanwhile, to record/reproduce data on the data area portions 121 to 124, evidently, the tracking control 171 will be necessary in addition to the focusing control 170. The data area portions 121 to 124 are provided with address information for specifying locations of first to last data so that information on the location where data should be recorded/reproduced can be recognized.

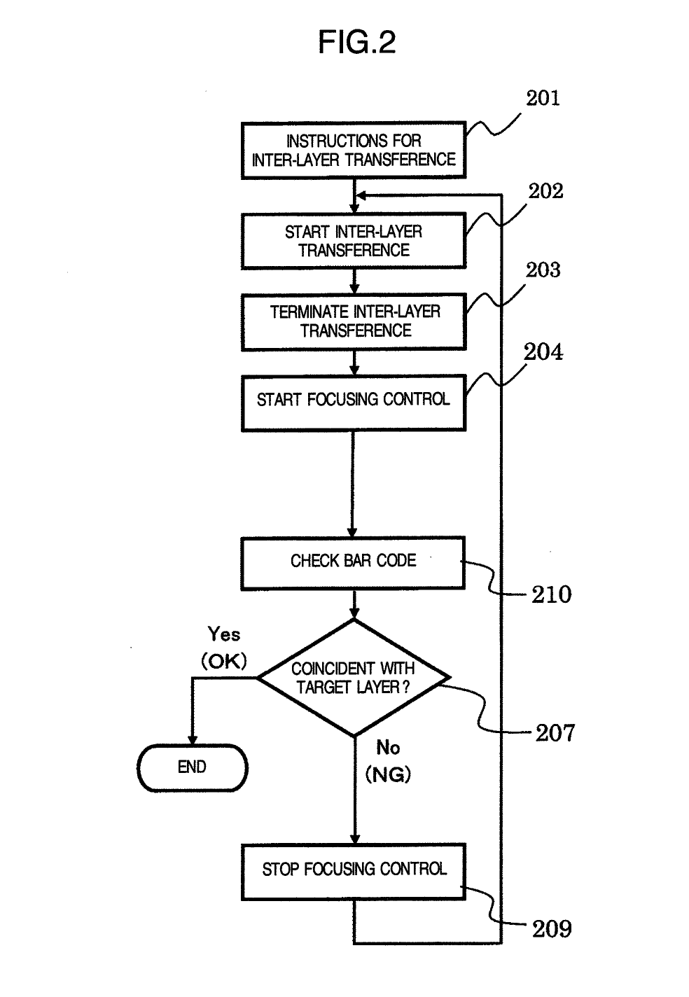

FIG. 2 is a diagram indicating a process of transference of a recording and reproducing pick-up between layers of a disc medium 100 according to another embodiment of the present invention.

First, the controller 16 receives instructions 201 for inter-layer transference from an external host or the like, and then the controller 16 controls the following steps of operation for the inter-layer transference. Transference of the recording and reproducing pick-up 160 is started (202) so that a light beam emission from the recording and reproducing pick-up 160 is directed to an intended layer or a target layer. Upon termination 203 of the inter-layer transference, focusing control is started (204). With the disc medium 100 as shown in FIG. 1A, the layers are provided with bar codes on their layer information area portions 111 to 114 of the layers, respectively, each bar code uniquely related to one layer. Since the bar codes are made of one-dimensional information, when the disc medium 100 is rotated, only focusing control of the recording and reproducing pick-up 160 is required to read them. Thus, since there is no need to start the tracking control 171, it is possible, soon after the start of the focusing control 204, to execute bar code check 210 to check whether an accessed layer is coincident with a target layer.

It should be noted that, since both focusing control and tracking control are impossible during the interval between the inter-layer transference start step 202 and the inter-layer transference termination step 203, the recording and reproducing pick-up 160 is driven by use of a fixed data for transference in order to transfer the pick-up 160 to a target layer. Therefore, it is essential to verify (207) that the accessed layer after completion of the inter-layer transference is coincident with a target layer. If no problem is found at the bar code check step 210, the transference process in FIG. 2 will be ended. While if it is found in the check step 210 that the accessed layer is not coincident with the target layer, the process will be returned to the inter-layer transference start step 202 for retrying the inter-layer transference. In this case, since the tracking control 171 is not effected, either, execution of stop 209 of focusing control will readily move the process to the inter-layer transference start step 202, which will lead to a rapid recovery of the process.

As described above, for transference of the recording and reproducing pick-up 160 to a target layer, it is necessary to make use of a fixed data for transference to drive the pick-up 160. Since the fixed data for transference is decided in consideration of the conditions such as of the disc medium 100 and the disc device 10, failure in the inter-layer transference, if any, will result, in most cases, in one layer of deviation of an accessed layer from a target layer. Therefore, if it is found in the bar code check step 210 that the accessed layer is not coincident with the target layer, the process may return to the step 202 of inter-layer transference start so that a transference by one layer is effected, and thereafter, the inter-layer transference process ends without the step 204 of focusing control start.

Description will now be made of the arrangement of the layer information area portions or bar code area portions on the disc layers, which carry layer information such as a bar code, with reference to the drawings.

In the disc medium shown in FIG. 1A, each of the layer information area portions or bar code area portions (hereafter, referred to as bar code area portions) 111 to 114 of the layers 101 to 104 is formed by a part of a circular path extending circumferentially of the layer concerned and carrying a bar code. Each of the circular paths has a center coincident with a center axis of rotation of the disc medium 100. The bar code area portions 111 to 114 or the circular paths by parts of which the bar code area portions are formed are at substantially identical radial positions from the center axis of rotation of the disc medium 100. Normally, movement of the recording and reproducing pick-up 160 to an innermost region 180 of the disc medium 100 is limited by an innermost position sensor provided in the vicinity of the region 180 within the medium 100, the sensor being not particularly shown. For inter-layer transference of the recording and reproducing pick-up 160, it is first moved to a critical position in the innermost region 180 to which the innermost position sensor allows the pick-up 160 to go, so that the transference between the layers is always performed at a substantially identical radial position from the center axis of rotation of the disc medium 100, which facilitates control of the inter-layer transference of the recording and reproducing pick-up 160.

Thus, in FIG. 1A, the bar code area portions 111 to 114 are at substantially identical radial positions from the center axis of rotation of the disc medium 100 and are arranged in the vicinity of the innermost region 180. Thereby, in the inter-layer transference process shown in FIG. 2, the bar code check step 210 for checking an accessed layer no longer needs movement of the recording and reproducing pick-up 160 in the radial direction to facilitate the inter-layer transference.

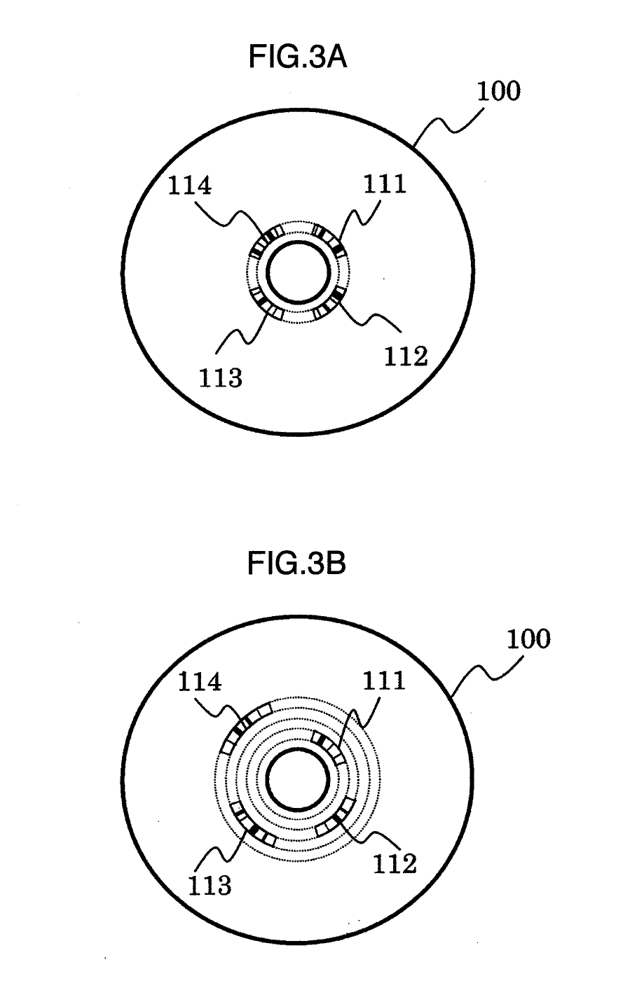

FIG. 3A is a diagram of a disc medium 100, as viewed in the direction of the rotation axis of the disc medium, according to another embodiment of the present invention, in which bar code area portions for layers are formed by parts of circular paths extending circumferentially of the layers. The circular paths have centers coincident with the center axis of rotation of the disc medium 100 and are at substantially identical radial positions from the center axis of rotation of the disc medium. Unlike in FIG. 1A in which the bar code area portions 111 to 114 are arranged so as to overlap one another as viewed in the thicknesswise direction of the disc medium 100, in the arrangement shown in FIG. 3A, the bar code area portions 111 to 114 do not overlap one another. Essentially, the bar code area portions 111 to 114 should be at substantially identical radial positions from the center axis of rotation of the disc medium 100 and it is immaterial whether the bar code area portions 111 to 114 are in an overlapped relation or not.

Another arrangement of the layer information area portions or bar code area portions on the disc layers according to another embodiment of the present invention will be described with reference to FIG. 1B. In the disc medium shown in FIG. 1B, bar code area portions 111 to 114 for layers 101 to 104 are formed by parts of circular paths extending circumferentially of the layers. The circular paths have their centers coincident with a center axis of rotation of the disc medium 100. Thus, the parts of the circular paths carry bar codes of the bar code area portions 111 to 114. Further, the bar code area portions 111 to 114 are displaced in such a manner that bar code area portions of adjacent layers are shifted in the radial direction of the layers from each other by a distance substantially identical with the width 190 of the bar code area portions, so that the bar code area portions are arranged stepwise as viewed in section taken in the thicknesswise direction of the disc medium 100.

The arrangement shown in FIG. 1A in which the bar code area portions are overlapped in the thicknesswise direction of the disc medium may suffer some interference between the bar codes when a bar code is checked: for example, reading of the bar code on the bar code area portion 112 may be influenced by the bar code on the bar code area portion 111.

To cope with this, in FIG. 1B, the bar code area portions 111 to 114 are arranged stepwise as viewed in section taken in the thicknesswise direction of the disc medium 100 in which adjacent bar code area portions are shifted by a distance identical with the width of the bar code area portions, as described above. Thereby, the arrangement shown in FIG. 1B will be free from any interference between the bar codes when the bar code on each of the bar code area portions 111 to 114 is read. A movement of the recording and reproducing pick-up 160 in the radial direction of the disc medium 100 in the process of the inter-layer transference may be accomplished by use of a fixed data for the movement in the radial direction decided depending on the position of the bar code on the bar code area portion of a target layer.

FIG. 3B is a diagram of a disc medium, as viewed in the direction of the disc rotation axis, according to another embodiment of the present invention, in which bar code area portions 111 to 114 for layers are formed by parts of circular paths extending circumferentially of the layers, the circular paths having their centers coincident with a center of rotation axis of the disc medium 100. The parts of the circular paths carry the bar codes of the bar code area portions 111 to 114. The bar code area portions arranged so as to be displaced in such a manner that bar code area portions of adjacent layers are shifted in the radial direction of the layers from each other by a distance substantially identical with the width 190 of the bar code area portions. In the arrangement of FIG. 3B, the bar code area portions 111 to 114 are further displaced in the circumferential direction of the layers from one another, in addition to in the radial direction.

It should be noted that, according to the teaching of the present invention, the displacement of the bar code area portions may be either in one or both of the radial and circumferential directions of the layers.

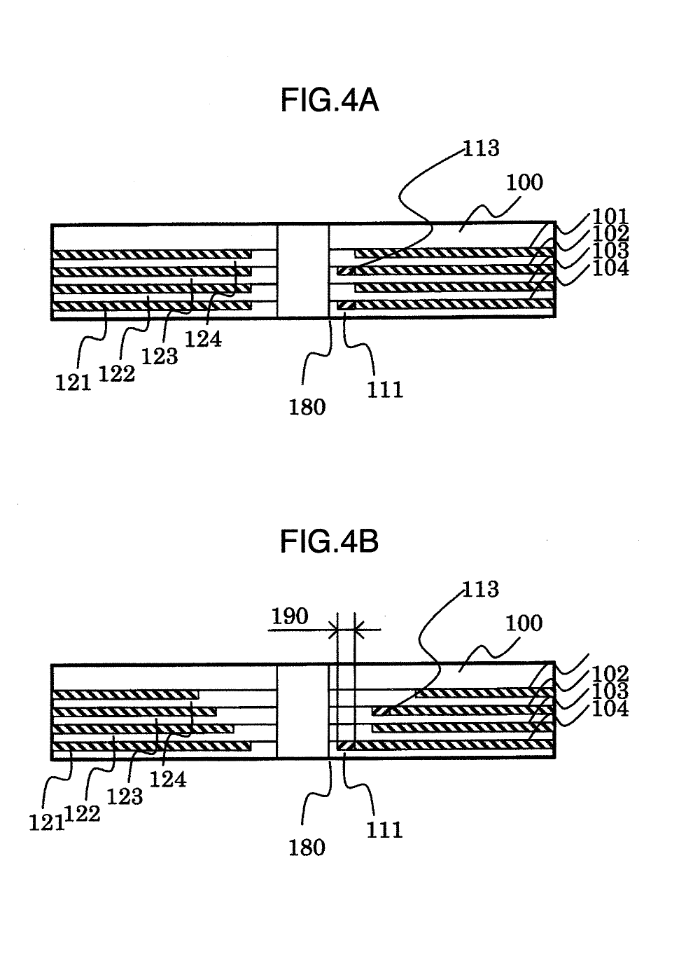

Referring now to FIG. 4A showing in section a disc medium 100 according to another embodiment of the present invention, bar code area portions are provided in alternate layers, unlike in the above-described embodiments in which a bar code area portion is provided in each layer. As has been described above in connection with FIG. 2, failure in the inter-layer transference, if any, will result, in most cases, in one layer of deviation of an accessed layer from a target layer.

Accordingly, as shown in FIG. 4A, bar code area portions 111 and 113 each carrying a bar code may be provided only in alternate layers 102 and 104, respectively, for example. With this arrangement, too, it is possible to accomplish a simplified check of an accessed layer in the inter-layer transference. When the recording and reproducing pick-up is transferred between layers, since it is known in advance whether the layer from which the pick-up is to be transferred has a bar code area portion or not, it can be also known that a target layer has a bar code area portion or not due to the fact that alternate layers are provided with bar code area portions. Thus, only by determining whether an accessed layer has a bar code area portion or not, it can be checked whether the accessed layer is coincident with the target layer.

When the accessed layer is not coincident with the target layer, the bar code on a bar code area portion of the accessed layer should be read if the accessed layer has the bar code area portion, while if not, address information should be read, thereby accomplishing transference to the target layer. Thus, it can be understood that bar code area portions each carrying a bar code may otherwise be provided only in alternate layers 101 and 103 to the same effect. In other words, bar code area portions may be provided either in even-numbered layers or in odd-numbered layers.

FIG. 4B shows in section a disc medium according to another embodiment of the present invention in which bar code area portions are provided on alternate layers and are displaced in such a manner that bar code area portions of the alternate layers are shifted in the radial direction from each other by a distance identical with the width of the bar code area portions, so that the bar code area portions are arranged stepwise as viewed in section taken in the thicknesswise direction of the disc medium.

In the above-described embodiments, the displaced arrangement of the bar code area portions of the layers carrying bar codes are such that the bar code area portions are shifted by a distance identical with the width of the bar code area portions in the radial directions of the layers so that the bar code area portions are arranged stepwise as viewed in section taken in the thicknesswise direction of the disc medium. However, the bar code area portions may be arranged circumferentially or radially of the layers in any manner, and/or may be provided in alternate layers of the multi-layered disc medium. Further, any combination of the above arrangements of the bar code area portions in such a manner that the bar code area portions may be provided “stepwise” (as described above) in alternate layers, or may be provided circumferentially or radially of the layers in any manner in alternate layers.

Additionally, a bar code may be disposed on the whole of a circular path extending circumferentially of a layer so that the bar code area portion is circular, or plural bar codes may be disposed on a circular path on one layer so that the circular path have plural bar code area portions, or plural bar codes may be carried on bar code area portions formed by parts of different plural circular paths extending circumferentially of one layer so that the bar codes are arranged in a radial direction of the layer. One or more bar codes may be disposed on a outermost circular path on a layer.

In the above embodiments, the layer information is described as containing one-dimensional information which can be read at the rotation of the disc medium, but it may contain information other than one-dimensional. In a modified embodiment of the present invention, the layer information for identifying a layer may be made of, other than one-dimensional information, a two-dimensional code. Namely, the layer information of the two-dimensional code is read, with the multi-layered disc medium 100 rotating, by the recording and reproducing pick-up 160 moving in a radial direction without the tracking control, whereby identification of a layer in the multi-layered disc medium can be achieved, as in the case of use of the bar code.

When use is made of a two-dimensional code as layer information for identifying a layer, the layer information area portions may be arranged “stepwise” as described, circumferentially or radially of the layers in any manner in one layer or in alternate layers. And, any combination of the above arrangements of the layer information area portions are possible. Additionally, other than the two-dimensional code, the layer information may be implemented by use of divisions of a circular path on a layer, which have different reflectivities or different colors, so that differences in the reflectivity or differences in the spectra of reflected light beams are sensed in order to achieve identification of the layer.

It should be further understood by those skilled in the art that although the foregoing description has been made on embodiments of the invention, the invention is not limited thereto and various changes and modifications may be made without departing from the spirit of the invention and the scope of the appended claims.

1. A disc medium comprising a plurality of reproducing or recording and reproducing layers having data area portions, wherein at least two of said layers further have layer information area portions, each of said layer information area portions being formed by at least a part of a circular path extending circumferentially of a layer concerned, layer information being disposed on each of at least the parts of the circular paths on said at least two layers, said layer information being capable of identifying a layer concerned, said circular paths having a center coincident with a center axis of rotation of the disc medium and being at substantially identical radial positions from the center axis of rotation of the disc medium.

2. A disc medium according to claim 1, wherein said layer information area portions are provided one on each of alternate ones of said layers.

3. A disc medium comprising a plurality of reproducing or recording and reproducing layers having data area portions, wherein at least one of said layers further has a layer information area portion, said layer information area portion being formed by at least a part of a circular path extending circumferentially of a layer, layer information being disposed on at least the part of the circular path on said at least one layer, said layer information being, for inter-layer transference, capable of identifying a layer concerned, said circular path having a center coincident with a center axis of rotation of the disc medium.

4. A disc medium according to claim 3, wherein said at least one layer includes two or more of said layers, the layer information area portions of different ones of said two or more layers are at substantially identical radial positions from said center axis of rotation of the disc medium.

5. A disc medium according to claim 3, wherein said at least one layer includes two or more of said layers, the layer information area portions of different ones of said two or more layers are at different radial positions from said center axis of rotation of the disc medium.

6. A disc medium according to claim 3, wherein said at least one layer includes two or more of said layers, the layer information area portions of different ones of said two or more layers are substantially at different radial positions from said center axis of rotation of the disc medium and are arranged stepwise as viewed in section taken in the thicknesswise direction of the disc medium.

7. A disc medium according to claim 3, wherein said at least one layer includes two or more of said layers, the layer information area portions of different ones of said two or more layers are at different radial positions from said center axis of rotation of the disc medium, a difference between said different radial positions being substantially identical with a width of said layer information area portions as viewed in a radial direction of the layers.

8. A disc medium according to claim 1 or 3, wherein each of said layer information area portions is arranged nearer to or farther from the center axis of rotation of the disc medium than each of said data area portions on the reproducing or recording and reproducing layer concerned.

9. A disc medium according to claim 1, wherein said layer information contains a bar code.

10. A disc medium according to claim 3, wherein said layer information contains a bar code.

11. A disc medium according to claim 1, wherein said layer information contains a two-dimensional code.

12. A disc medium according to claim 3, wherein said layer information contains a two-dimensional code.

13. A disc device for a detachable disc medium,
said detachable disc medium including a plurality of reproducing or recording and reproducing layers wherein at least two of said layers have layer information area portions, each of said layer information area portions being formed by at least a part of a circular path extending circumferentially of a layer concerned, layer information being disposed on each of at least the parts of the circular paths on said at least two layers, said layer information being capable of identifying a layer concerned, said circular paths having a center coincident with a center axis of rotation of the disc medium and being at substantially identical radial positions from the center axis of rotation of the disc medium,
said disc device comprising:
means for reading the layer information on the layer information area portions of the layers; and
a controller serving to verify, when transference from one layer to another layer to be accessed among said layers is effected, said another layer having been accessed, by use of the layer information carried on the layer information area portion of the accessed layer.

14. A disc device according to claim 13, wherein said controller serves to re-try transference to another layer when it is found as result of verification by said controller that the accessed layer is not coincident with a target layer intended by the transference.

15. A disc device according to claim 13, wherein said controller serves to verify the accessed layer by use of information as to whether or not the accessed layer has a layer information area portion.

16. A disc device for a detachable disc medium,
said detachable disc medium including a plurality of reproducing or recording and reproducing layers wherein at least two of said layers have layer information area portions, each of said layer information area portions being formed by at least a part of a circular path extending circumferentially of a layer concerned, layer information being disposed on each of at least the parts of the circular paths on said at least two layers, said layer information being capable of identifying a layer concerned, said circular paths having a center coincident with a center axis of rotation of the disc medium,
said disc device comprising:
means for reading the layer information on the layer information area portions of the layers; and
a controller serving to verify, when transference from one layer to another layer to be accessed among said layers is effected, said another layer having been accessed, by use of the layer information carried on the layer information area portion of the accessed layer.

17. A disc device according to claim 16, wherein said controller serves to re-try transference to another layer when it is found as result of verification by said controller that the accessed layer is not coincident with a target layer intended by the transference.

18. A disc device according to claim 16, wherein said controller serves to verify the accessed layer by use of information as to whether or not the accessed layer has a layer information area portion.
